(19) United States
(12) Patent Application Publication
(10) Pub. No.: US 2009/0109563 A1
(43) Pub. Date: Apr. 30, 2009

(54) BURST INTERVAL MEASURING APPARATUS, BURST INTERVAL MEASURING METHOD, DRIVE APPARATUS, SERVO PATTERN WRITING APPARATUS, AND MAGNETIC TAPE TESTING APPARATUS

(75) Inventors: Takashi HANDA, Tokyo (JP); Koji MATSUNO, Tokyo (JP); Osamu INOUE, Tokyo (JP); Keiji TESHIMA, Tokyo (JP); Kazutaka FUJITA, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/245,977

(22) Filed: Oct. 6, 2008

(30) Foreign Application Priority Data
Oct. 25, 2007 (JP) 2007-277447

(51) Int. Cl. G11B 27/36

(52) U.S. Cl. 360/31; G9B/27.052

(57) ABSTRACT

A burst interval measuring apparatus includes: a detector that outputs detection signals that can to measure a burst interval of servo patterns for a tracking servo; and a measuring unit that measures the burst interval based on the detection signals. The detector is constructed so as to be capable of outputting the detection signals that can measure the burst interval at plural positions that are separated in a width direction of the magnetic tape inside one of the servo patterns. The measuring unit uses measurement values for the burst interval at at least two positions out of the plural positions that have been measured based on the detection signals to specify velocity fluctuations in a movement velocity of the magnetic tape in the length direction and corrects the measurement values based on the velocity fluctuations.

### BACKGROUND OF THE INVENTION

1. Field of the Invention

The present invention relates to a burst interval measuring apparatus that measures burst intervals of servo patterns used for tracking control, a burst interval measuring method that measures burst intervals, a drive apparatus that carries out tracking control using burst intervals, a servo pattern writing apparatus that writes servo patterns onto a magnetic tape, and a magnetic tape testing apparatus that tests a magnetic tape on which servo patterns have been written.

2. Description of the Related Art

A recording medium equipped with a magnetic tape on which a large number of data tracks are provided so that a large amount of data can be recorded by recording data on the respective tracks is known. When recording and reproducing data using this type of recording medium, the narrower the track width of the magnetic tape, the higher the accuracy required for tracking that keeps the recording/reproducing magnetic head on a track. As a technology for carrying out such accurate tracking, a servo control system disclosed by Japanese Patent No. 3158015 is known. In this servo control system, tracking is carried out using servo patterns (for example, inverse-V-shaped servo patterns) for tracking servo that are recorded on servo tracks provided along the length of the magnetic tape. More specifically, when the magnetic tape moves in the length direction thereof, a servo read head detects the servo patterns and generates a servo read head signal that is supplied to a signal decoder. In such case, the distance between peaks that appear in the servo read head signal will change in accordance with the position of the servo read head along the width direction of the servo tracks (or magnetic tape). This means that by measuring the distances between peaks (i.e., the “burst intervals” of the servo patterns), it is possible to specify the position of the servo read head in a servo track. After this, the signal decoder processes the servo read head signal to generate a position signal and supplies the position signal to a servo controller. Next, the servo controller generates a control signal and supplies the control signal to a servo mechanism of the head assembly. After this, the servo mechanism moves the servo read head in the width direction of the servo track in accordance with the control signal. By doing so, tracking is carried out.

### SUMMARY OF THE INVENTION

However, by investigating the servo control system described above and a recording/reproducing apparatus equipped with such servo control system, the present inventors found the following problem. That is, in this type of servo system including the servo control system described above, the servo read head detects the servo pattern in a state where the magnetic tape is moved in the length direction to generate the servo read head signal and tracking is carried out based on the position signal produced by processing the servo read head signal. Here, since the burst intervals will be accurately measured when the movement velocity of the magnetic tape is kept constant, it will be possible to accurately specify the position of the servo read head in the servo track and carry out accurate tracking. However, with this type of servo control system and recording/reproducing apparatus, the movement velocity of the magnetic tape will vary due to rotational fluctuations or vibrations of the motor, and when such fluctuations occur, the distance between the peaks that appear in the servo read head signal will also fluctuate due to such fluctuations, which makes it difficult to accurately measure the burst intervals. As a result, there is the problem that it is difficult to specify the correct position of the servo read head in a servo track, or in other words, it is difficult to carry out accurate tracking. Research is being carried out into a technology that cancels out fluctuations in the movement velocity of the magnetic tape by using servo patterns of a different shape (such as N-shaped patterns) to the inverse-V-shaped patterns that are normally used. However, when using servo patterns of a different shape to inverse-V-shaped patterns, it becomes difficult to record and reproduce data using recording/reproducing apparatuses that are only compatible with inverse-V-shaped servo patterns, or in other words, recording media will no longer be compatible with such apparatuses.

The present invention was conceived in view of the problem described above and it is a principal object of the present invention to provide a burst interval measuring apparatus, a burst interval measuring method, and a drive apparatus that can accurately measure burst intervals even in a state where the movement velocity of the magnetic tape fluctuates. It is another principal object of the present invention to provide a servo pattern writing apparatus that can accurately write servo patterns used for a tracking servo and a magnetic tape testing apparatus that can determine whether servo patterns have been accurately written.

To achieve the stated object, a burst interval measuring apparatus according to the present invention includes: a detector that outputs detection signals that can measure a burst interval of servo patterns for a tracking servo that have been written on a magnetic tape in a length direction of the magnetic tape; and a measuring unit that measures the burst interval based on the detection signals, wherein the detector is constructed so as to be capable of outputting the detection signals that can measure the burst interval at a plurality of positions that are separated in a width direction of the magnetic tape inside one of the servo patterns, and the measuring unit uses measurement values for the burst interval at at least two positions out of the plurality of positions that have been measured based on the detection signals to specify velocity fluctuations in a movement velocity of the magnetic tape in the length direction thereof and corrects the measurement values based on the velocity fluctuations.

A burst interval measuring method according to the present invention measures, based on detection signals outputted from a detector, a burst interval of servo patterns for a tracking servo that have been written on a magnetic tape in a length direction of the magnetic tape, the burst interval measuring method including: measuring the burst interval based on the detection signals at at least two positions that are separated in a width direction of the magnetic tape inside one of the servo patterns; specifying velocity fluctuations in a movement velocity of the magnetic tape along the length direction thereof using measurement values for the burst interval; and correcting the measurement values based on the velocity fluctuations.

The burst interval measuring apparatus and burst interval measuring method according to the present invention measure, based on the detection signals, the burst interval at at least two positions that are separated in a width direction of the magnetic tape inside one servo pattern and specify velocity fluctuations in a movement velocity of the magnetic tape in the length direction thereof using the measurement values for the burst interval. This means that according to this burst interval measuring apparatus and burst interval measuring method, it is possible to correct the measurement values based on the specified velocity fluctuations to the same value as the actual burst interval, and therefore it is possible to accurately measure the burst interval even when the movement velocity is fluctuating.

A drive apparatus according to the present invention includes: a magnetic head that carries out at least one of reproducing of data recorded on a magnetic tape and recording of data on the magnetic tape; a detector that outputs detection signals that can measure a burst interval of servo patterns for a tracking servo that have been written on the magnetic tape in a length direction of the magnetic tape; and a controller that measures the burst interval based on the detection signals and carries out tracking control of the magnetic head using measurement values for the burst interval, wherein the detector is constructed so as to be capable of outputting the detection signals that can measure the burst interval at a plurality of positions that are separated in a width direction of the magnetic tape inside one of the servo patterns, and the measuring unit uses measurement values for the burst interval at at least two positions out of the plurality of positions that have been measured based on the detection signals to specify velocity fluctuations in a movement velocity of the magnetic tape in the length direction thereof, corrects the measurement values based on the velocity fluctuations, and carries out the tracking control using the corrected measurement values.

According to the drive apparatus according to the present invention, the detector is constructed so as to be capable of outputting detection signals that can measure the burst interval for a plurality of positions that are separated in the width direction of the magnetic tape inside one servo pattern. This means that the measuring unit can specify the velocity fluctuations in the movement velocity of the magnetic tape using measurement values of the burst interval for at least two positions out of the plurality of positions that have been measured based on the detection signals. Therefore, according to this drive apparatus, since it is possible to correct the measurement values based on the specified velocity fluctuations to the same values as the actual burst interval, it will be possible to accurately measure the burst interval even when the movement velocity is fluctuating. As a result, even when the movement velocity is fluctuating, it will still be possible to accurately specify the tracking amount, which means it will be possible to carry out accurate tracking.

Here the detector may include a number of detection elements that output the detection signals that is equal to at least (twice the number of servo tracks in a servo band in which the servo pattern has been written minus one), and the measuring unit may specify the velocity fluctuations using the measurement values for two positions out of the plurality of positions that have been measured based on the detection signals outputted from two detection elements out of the detection elements. By using this construction, by disposing the detection elements at equal intervals in a length that is around twice the length of a servo pattern along the width direction of the magnetic tape, for example, it will always be possible to position two out of the detection elements at both ends in the height direction of a servo pattern where the difference in the burst interval is large. Accordingly, since the difference between the two measurement values measured based on the detection signals outputted from such two detection elements is large, by calculating the velocity fluctuations using such difference, the measurement error of the measurement values can be suppressed. As a result, the velocity fluctuations can be specified with a corresponding improvement in accuracy.

A servo pattern writing apparatus according to the present invention includes: a moving mechanism that moves a magnetic tape along a length direction thereof; a write head that writes servo patterns for a tracking servo along the length direction of the magnetic tape while the magnetic tape is moving; a controller that controls the moving mechanism; and a detector that outputs detection signals that can measure a burst interval at a plurality of positions that are separated in a width direction of the magnetic tape inside one of the servo patterns, wherein the controller specifies velocity fluctuations in a movement velocity of the magnetic tape along the length direction thereof using measurement values for the burst interval at at least two positions out of the plurality of positions that have been measured based on the detection signals and controls the moving mechanism so as to reduce the velocity fluctuations.

The servo pattern writing apparatus according to the present invention is constructed so as to include the detector that outputs detection signals that can measure the burst interval at a plurality of positions that are separated in the width direction of the magnetic tape inside one servo pattern. This means that the controller can specify the velocity fluctuations in the movement velocity of the magnetic tape using the measurement values of the burst interval for at least two positions out of the plurality of positions that have been measured based on the detection signals. Therefore, according to this servo pattern writing apparatus, by controlling the moving mechanism so as to reduce the specified velocity fluctuations, it is possible to suppress fluctuations in the movement velocity of the magnetic tape. As a result, it is possible to record the servo patterns at equal intervals.

Also, a magnetic tape testing apparatus according to the present invention tests a magnetic tape on which servo patterns for a tracking servo have been written by a servo pattern writing apparatus that writes the servo patterns along a length direction of the magnetic tape while moving the magnetic tape in the length direction, the magnetic tape testing apparatus including: a detector that outputs detection signals that can measure a burst interval at a plurality of positions that are separated in a width direction of the magnetic tape inside one of the servo patterns; and a determining unit that specifies velocity fluctuations in a movement velocity of the magnetic tape in the length direction using measurement values of the burst interval for at least two positions out of the plurality of positions that have been measured based on the detection signals, and determines that the magnetic tape is defective when the velocity fluctuations are outside a predetermined range.

The magnetic tape testing apparatus according to the present invention includes a detector that outputs detection signals that can measure the burst interval for a plurality of positions that are separated in the width direction of the magnetic tape inside one servo pattern. This means that the determining unit can specify the velocity fluctuations in the movement velocity of the magnetic tape using the measurement values for the burst interval for at least two positions out of a plurality of positions that have been measured based on the detection signals. Therefore, according to this magnetic tape testing apparatus, by determining that a magnetic tape where the specified velocity fluctuations are outside a predetermined range is defective, it will be possible, when the servo patterns were recorded on the magnetic tape in a state where the movement velocity of the magnetic tape was fluctuating with velocity fluctuations that are outside the predetermined range, to reliably exclude such magnetic tape (i.e., a magnetic tape where the recorded state of the servo patterns is not favorable) from the products.

It should be noted that the disclosure of the present invention relates to a content of Japanese Patent Application 2007-277447 that was filed on 25 Oct. 2007 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a block diagram showing the construction of a drive apparatus;

FIG. 2 is a diagram useful in explaining the construction of a magnetic tape and how a head unit is disposed;

FIG. 3 is a diagram useful in explaining the construction of a head unit;

FIG. 4 is a first diagram useful in explaining a tracking method;

FIG. 5 is a second diagram useful in explaining the tracking method;

FIG. 6 is a third diagram useful in explaining the tracking method;

FIG. 7 is a block diagram showing the construction of a tape cartridge manufacturing apparatus; and

FIG. 8 is a block diagram showing the construction of a servo writer.

### DESCRIPTION OF THE PREFERRED EMBODIMENTS

Preferred embodiments of a burst interval measuring apparatus, a burst interval measuring method, a drive apparatus, a servo pattern writing apparatus, and a magnetic tape testing apparatus according to the present invention will now be described with reference to the attached drawings.

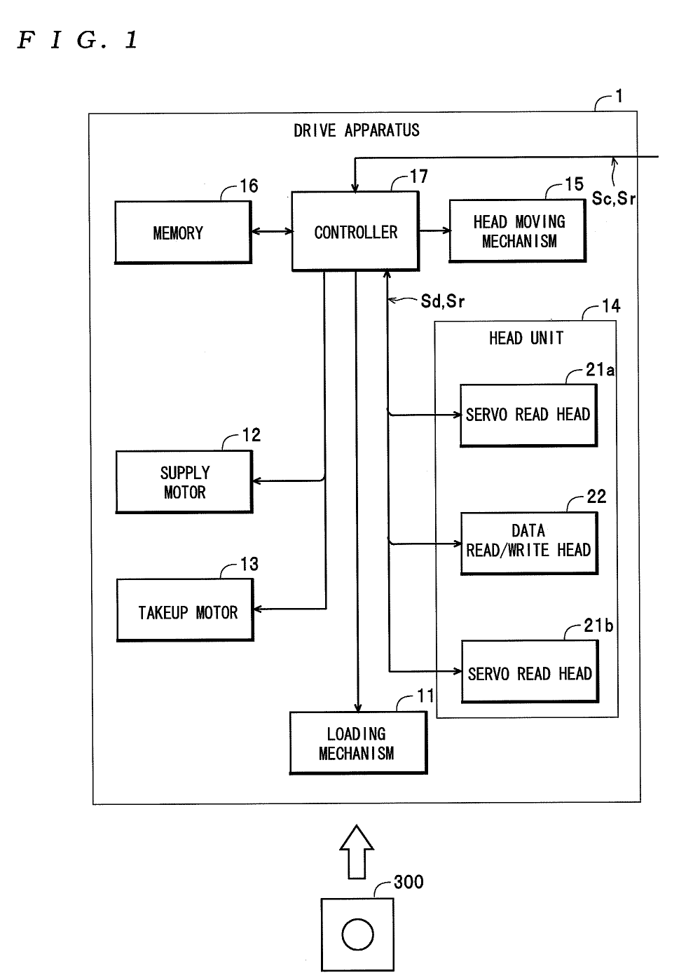

First, the construction of a drive apparatus 1 will be described. The drive apparatus 1 shown in FIG. 1 is one example of a “drive apparatus” according to the present invention and is constructed so as to be capable of recording data on a tape cartridge 300 (i.e., a magnetic tape 301, described later) and/or reproducing data that has been recorded on the tape cartridge 300.

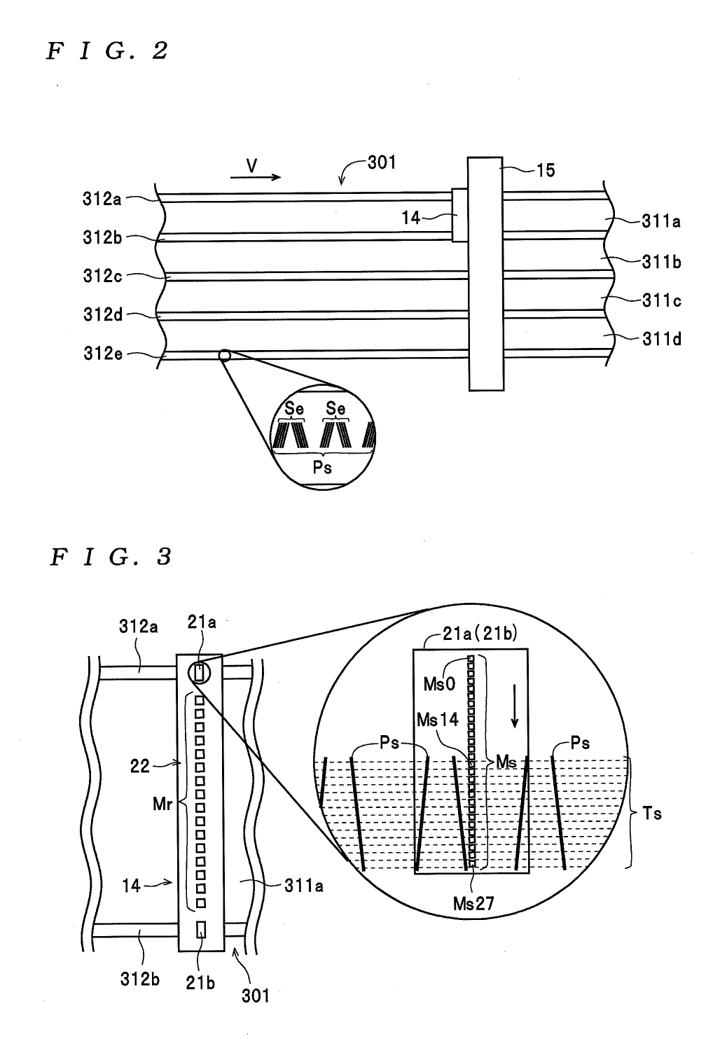

As one example, the tape cartridge 300 is a large-capacity information medium used when backing up data recorded in a computer and as one example is constructed so as to include the magnetic tape 301 that is wound around a single tape reel (not shown). In this case, the tape cartridge 300 is manufactured by a tape cartridge manufacturing apparatus 100, described later. As shown in FIG. 2, the magnetic tape 301 includes a plurality (in this example, four) of data bands 311a to 311d along the length direction thereof (hereinafter, the data bands 311a to 311d are collectively referred to as the data bands 311 when no distinction is required), with a plurality (in this example, 176) of data tracks being respectively provided on each of the data bands 311. Also, as shown in FIG. 2, servo bands 312a to 312e (hereinafter, the servo bands 312a to 312e are collectively referred to as the “servo bands 312” when no distinction is required) are provided along the length direction of the magnetic tape 301 at both ends in the width direction of the magnetic tape 301 and between the respective data bands 311. Servo patterns Ps are respectively written along the length direction of the magnetic tape 301 on each of the servo bands 312. When the recording or reproducing of data is carried out on the magnetic tape 301 by the drive apparatus 1, the servo patterns Ps serve as tracking servo patterns used for tracking control of a head unit 14 (a data read/write head 22: see FIG. 3) of the drive apparatus 1. As shown in FIG. 2, as one example each servo pattern Ps is constructed of a plurality of segments (lines) Se, with pairs of facing segments Se being formed so as to become gradually distant from one another toward one end (the lower end in FIG. 2) thereof to form inverse-V shapes. The servo patterns Ps are written into the respective servo bands 312 of the magnetic tape 301 by a servo writer 102 (see FIG. 7) of the tape cartridge manufacturing apparatus 100. Note that in FIGS. 3 to 6, for ease of understanding the present invention, the segments Se of the servo patterns Ps are illustrated as single lines.

On the other hand, as shown in FIG. 1, the drive apparatus 1 includes a loading mechanism 11, a supply motor 12, a takeup motor 13, the head unit 14, a head moving mechanism 15, a memory 16, and a controller 17. In accordance with control by the controller 17, the loading mechanism 11 loads the tape cartridge 300 and pulls out the magnetic tape 301 from the tape cartridge 300. The supply motor 12 feeds out the magnetic tape 301 by rotating the tape reel of the tape cartridge 300. The takeup motor 13 rotates a takeup reel, not shown, to wind on the magnetic tape 301. In this case, a “moving mechanism” for the present invention is constructed of the supply motor 12 and the takeup motor 13, and by controlling the rotational velocity of the supply motor 12 and the takeup motor 13 using the controller 17, the magnetic tape 301 is moved at a predetermined movement velocity V.

As shown in FIG. 3, the head unit 14 includes servo read heads 21a, 21b (a “detector” for the present invention, hereinafter referred to as the “servo read heads 21” when no distinction is required) and the data read/write head 22 (a “magnetic head” for the present invention). The servo read heads 21 each include a plurality of detection elements Ms0 to Ms27 (hereinafter referred to as “detection elements Ms” when no distinction is required). Each detection element Ms detects the segments Se that construct a servo pattern Ps and outputs a detection signal Sd that can measure the burst intervals (i.e., intervals between facing segments Se) in the servo pattern Ps. In this case, the number of detection elements Ms provided in each of the servo read heads 21 is set at twice the number of servo tracks Ts (see FIG. 3) provided inside a servo band 312 on the magnetic tape 301 (one example of a number that is “at least (twice the number of servo tracks minus one)”). In this example, the number of servo tracks Ts is fourteen and the number of detection elements Ms is twenty-eight. The respective detection elements Ms are disposed at equal intervals with a pitch that is equal to the pitch of the servo tracks Ts within a length that is around twice the length along the up-down direction (i.e., the width direction of the magnetic tape 301) of a servo pattern Ps. That is, the servo read heads 21 are constructed so as to be capable of outputting detection signals (the detection signals Sd from the detection elements Ms (see FIG. 1)) that can measure burst intervals at a plurality of positions that are separated in the width direction of the magnetic tape 301 within one servo pattern Ps.

The data read/write head 22 is constructed of a plurality of (as one example, sixteen) magnetic elements Mr and carries out recording of data and reproducing of recorded data on data tracks provided in a data band 311 on the magnetic tape 301.

In accordance with control by the controller 17, the head moving mechanism 15 moves the head unit 14 along the width direction of the magnetic tape 301. The memory 16 stores measurement values Pm, reference values Po, burst intervals Pr, and the like.

The controller 17 controls the various units that construct the drive apparatus 1 in accordance with control signals Sc inputted from an external apparatus such as a computer. The controller 17 also functions as a “measuring unit” for the present invention and measures the burst intervals based on the detection signals Sd outputted from the servo read heads 21 of the head unit 14. The controller 17 corrects the measurement values Pm of the burst intervals and carries out tracking control of the head unit 14 (i.e., the data read/write head 22) using the corrected values. By carrying out a process, described later, that uses the measurement values Pm of the burst interval which relate to two measured positions (one example of “at least two positions” for the present invention) in a servo pattern Ps that are separated in the width direction of the magnetic tape 301 and which were measured based on the detection signals Sd for such measured positions, the controller 17 specifies a velocity fluctuation rate F (the velocity fluctuation for the present invention) for the movement velocity V of the magnetic tape 301 along the length direction (as one example, the velocity fluctuation rate F=actual movement velocity V/movement velocity V set in advance) and carries out tracking control using corrected values produced by correcting the measurement values Pm based on the velocity fluctuation rate F.

Next, the operation of the various component elements of the drive apparatus 1 will be described.

For example, when using the drive apparatus 1 to reproduce data that has been recorded on the tape cartridge 300, the tape cartridge 300 is set in the drive apparatus 1. When doing so, the loading mechanism 11 moves the tape cartridge 300 toward a front end portion of a rotational shaft, not shown, to clamp the rotational shaft and the tape reel of the tape cartridge 300. Next, the loading mechanism 11 pulls the magnetic tape 301 wound around the tape reel out of the tape cartridge 300 and winds the magnetic tape 301 onto the takeup reel.

Next, reproducing of the data is indicated by operating a computer connected to the drive apparatus 1. After this, the controller 17 carries out a reproducing process in accordance with the control signals Sc outputted from the computer. In this reproducing process, the controller 17 first controls the supply motor 12 and the takeup motor 13 to move the magnetic tape 301 at the predetermined movement velocity V and feeds out and winds on the magnetic tape 301. The controller 17 controls the head moving mechanism 15 and as one example, as shown in FIG. 3, moves the head unit 14 so that the lower fourteen detection elements Ms in FIG. 3 (i.e., the detection elements Ms14 to Ms27) out of the detection elements Ms of a servo read head 21 of the head unit 14 are positioned substantially on the fourteen servo tracks Ts of the servo band 312a. When doing so, the magnetic elements Mr of the data read/write head 22 of the head unit 14 become positioned on one data band 311 (for example, the data band 311a) out of the data bands 311.

Next, the respective detection elements Ms14 to Ms27 detect the segments Se that construct the servo pattern Ps and output detection signals Sd that can measure the burst intervals at positions that are separated in the width direction of the magnetic tape 301 within the servo pattern Ps. As one example, each detection signal Sd is a signal that shows changes in voltage, and whenever a segment Se approaches a detection element Ms due to movement of the magnetic tape 301, that is, in each period that corresponds to a burst interval, there is a peak in the voltage value of the detection signal Sd. This means that it is possible to measure the burst interval based on the time between such peaks.

Next, the controller 17 carries out a burst interval measuring process based on the detection signals Sd. In this burst interval measuring process, based on the time between adjacent peaks in the detection signals Sd and the movement velocity V of the magnetic tape 301 that is set in advance, the controller 17 measures the burst intervals (by multiplying the two values, for example).

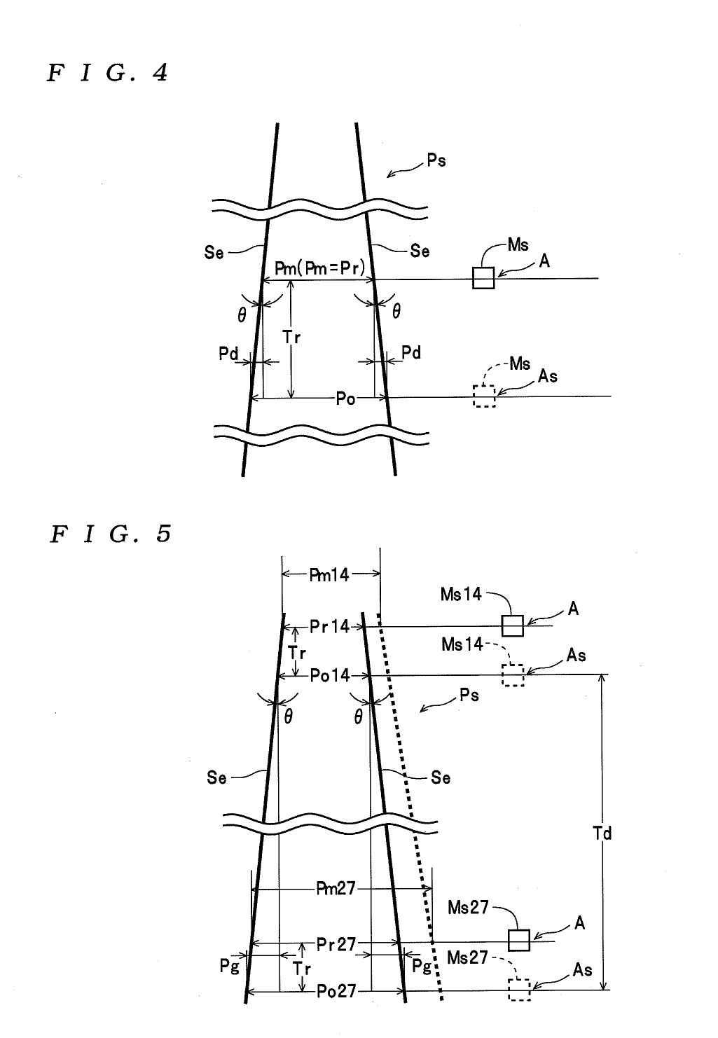

Here, when the movement velocity V of the magnetic tape 301 is the set velocity that is set in advance and there are no velocity fluctuations in the movement velocity V, as shown in FIG. 4, the measurement value Pm for the burst interval calculated by the method described above will match the actual burst interval Pr. In this case, each servo pattern Ps is recorded by transferring a pattern of a form and size that are set in advance. This means that the burst interval Pr of one servo pattern Ps, or in other words, the distance between segments Se that construct one servo pattern Ps will be universally specified by the position A in the up-down direction (i.e., the width direction of the magnetic tape 301) of the servo pattern Ps. Accordingly, it will be possible to specify the position A at which the detection element Ms is positioned from the burst interval Pr.

Here, as shown in FIG. 4, each segment Se that constructs the servo pattern Ps is inclined by a predetermined inclination angle θ (as one example, 6°) with respect to the width direction of the magnetic tape 301. The relationship between (i) the distance between the position A at which a detection element Ms is positioned and a target position As to which such detection element Ms should be moved by tracking control, or in other words, the tracking amount Tr to be used during tracking control and (ii) a value (hereinafter such value is referred to as the “difference value Pd”: see FIG. 4) that is half the difference between the burst interval at the target position As (hereinafter, the burst interval at the target position As will be referred to as the “reference value Po”) and the burst interval Pr at the position A is expressed by the following equation.

Pd=Tr×tanθ Equation (1)

From Equation (1), the relationship between the burst interval Pr and the reference value Po can be expressed by the following equation.

Pr=Po−2×Tr×tanθ Equation (2)

Rearranging Equation (2) produces the following equation.

Tr=(Po−Pr)/(2×tanθ) Equation (3)

As described above, when the reference value Po is universally specified by the target position As, if there are no velocity fluctuations in the movement velocity V of the magnetic tape 301, by measuring the measurement value Pm that has the same value as the burst interval Pr, it will be possible to accurately specify the tracking amount Tr from Equation (3).

On the other hand, when the movement velocity V of the magnetic tape 301 is fluctuating (i.e., when there are velocity fluctuations), the measurement value Pm for the burst interval will differ to the actual burst interval Pr. For example, when the movement velocity V is slower than the set velocity, as shown in FIG. 5, the measurement value Pm (for example, the measurement value Pm14) will be measured as being longer than the burst interval Pr (in this example, the burst interval Pr14). Accordingly, when the movement velocity V is fluctuating, it becomes difficult to accurately specify the tracking amount Tr and as a result, it is difficult to carry out accurate tracking control. For this reason, in the drive apparatus 1, the controller 17 specifies (i.e., calculates) the velocity fluctuation rate F of the movement velocity V of the magnetic tape 301 and corrects the measurement values Pm based on such velocity fluctuation rate F to find the actual burst intervals Pr. More specifically, the controller 17 carries out the following process, for example.

For example, assume that the movement velocity V of the magnetic tape 301 is fluctuating when tracking control is carried out on the magnetic tape 301 that is moving in the length direction thereof. Here, as shown in FIG. 5, when the measurement value Pm calculated based on the detection signal Sd outputted from the detection element Ms14 out of the detection elements Ms of a servo read head 21 is expressed as a measurement value Pm14 and the measurement value Pm calculated based on the detection signal Sd outputted from the detection element Ms27 is expressed as a measurement value Pm27, the following equation is defined to calculate the velocity fluctuation rate F.

Pm27−Pm14 Equation (4)

Here, the relationship between the measurement value Pm, the burst interval Pr, and the velocity fluctuation rate F is expressed by the following equation.

Pm=Pr×F Equation (5)

Substituting Equation (5) into Equation (4) produces the following modified equation.

Pm27−Pm14=Pr27×F−Pr14×F Equation (6)

Here, if the reference value Po for the detection element Ms14 is expressed as the reference value Po14 and the reference value Po for the detection element Ms27 is expressed as the reference value Po27, substituting Equation (2) into Equation (6) produces the following modified equation.

$$\begin{matrix}Pr 27 \times F - Pr 14 \times F = ( Po 27 - 2 \times Tr \times tan θ ) \times \\ F - ( Po 14 - 2 \times Tr \times tan θ ) \times F \\ = ( Po 27 - Po 14 ) \times F\end{matrix} \qquad Equation ( 7 )$$

The following equation is found from Equation (7).

F=(Pm27−Pm14)/(Po27−Po14) Equation (8)

Here, since the reference values Po14, Po27 are universally specified as described above, based on the two measurement values Pm14, Pm27, it is possible to calculate the velocity fluctuation rate F from Equation (8). Rearranging Equation (5) also produces the following equation.

Pr=Pm/F Equation (9)

By substituting the velocity fluctuation rate F found from Equation (8) into Equation (9) (i.e., by multiplying the measurement value Pm and the velocity fluctuation rate F), it is possible to calculate the actual burst interval Pr. That is, it is possible to correct the measurement value Pm. By substituting the calculated burst interval Pr (i.e., the measurement value Pm after correction) into Equation (3), it is possible to specify the tracking amount Tr.

Here, the value of the denominator (Po27−Po14) on the right side of Equation (8) given above corresponds to the difference between the reference value Po27 for the detection element Ms27 and the reference value Po14 for the detection element Ms14. In this case, if the distance between the detection element Ms27 and the detection element Ms14 along the width direction of the magnetic tape 301 is set as the distance Td (see FIG. 5), as should be clear from FIG. 5, a value that is half the difference between the reference value Po27 and the reference value Po14 (hereinafter such value is referred to as the “difference value Pg”: see FIG. 5) can be expressed from the following equation.

Pg=Td×tanθ Equation (10)

Accordingly, the value (Po27−Po14) given above can be expressed by the following equation.

(Po27−Po14)=2×Td×tanθ Equation (11)

Substituting Equation (11) into Equation (8) produces the following modified equation.

F=(Pm27−Pm14)/(2×Td×tanθ) Equation (12)

In this case, the distance Td between the detection element Ms27 and the detection element Ms14 will be constant regardless of the positions A and target positions As of the detection elements Ms27, Ms14, and therefore the value of the denominator (2×Td×tanθ) on the right side of Equation (12) will also be universally determined by the distance Td. Accordingly, without depending on Equation (8) that uses the reference values Po14, Po27 described above, by using the two measurement values Pm14, Pm27 and the distance Td between the detection elements Ms27, Ms14 (i.e., the distance between two measuring positions along the width direction of the magnetic tape within a servo pattern Ps), it is also possible to find the velocity fluctuation rate F using Equation (12) given above.

According to the processing described above, even if the movement velocity V of the magnetic tape 301 is fluctuating, it will still be possible to calculate the velocity fluctuation rate F of the movement velocity V from the measurement values Pm measured based on the detection signals Sd outputted from two detection elements Ms of a servo read head 21. Accordingly, since it is possible for the drive apparatus 1 to calculate the actual burst interval Pr from the calculated velocity fluctuation rate F, the tracking amount Tr can be accurately specified even when the movement velocity V is fluctuating.

Next, the controller 17 controls the head moving mechanism 15 to move the head unit 14 by the tracking amount Tr. In this way, by positioning the respective detection elements Ms of the servo read heads 21 at the target position As, the magnetic elements Mr of the data read/write head 22 of the head unit 14 become positioned at the respective data tracks to be reproduced, thereby completing the tracking. When doing so, as described above, since the tracking amount Tr can be accurately specified by the controller 17, accurate tracking is carried out. After this, the magnetic elements Mr reproduce data and output reproducing signals Sr, and the controller 17 outputs the reproducing signals Sr to the computer.

Next, at a point when the magnetic tape 301 has been entirely wound around the takeup reel, for example, the controller 17 controls (i.e., stops) the operation of the motors 12, 13 to stop the movement, feeding out, and winding on of the magnetic tape 301. After this, the controller 17 controls the head moving mechanism 15 to move the head unit 14 downward (in the direction of the arrow in FIG. 3) along the width direction of the magnetic tape 301 by a distance that corresponds to the width of one servo track Ts, for example. Next, by controlling the motors 12, 13, the magnetic tape 301 is moved in the reverse direction to the first direction of movement. After this, the controller 17 carries out tracking by carrying out the various processes and control described above, and the reproducing signals Sr outputted from the magnetic elements Mr of the data read/write head 22 of the head unit 14 are outputted to the computer. Next, the controller 17 carries out the reproducing process described above a predetermined number of times, and by moving the head unit 14 back and forth relative to the magnetic tape 301 multiple times, the data recorded on the plurality (in this example, 176) of data tracks on a data band 311 on the magnetic tape 301 is reproduced.

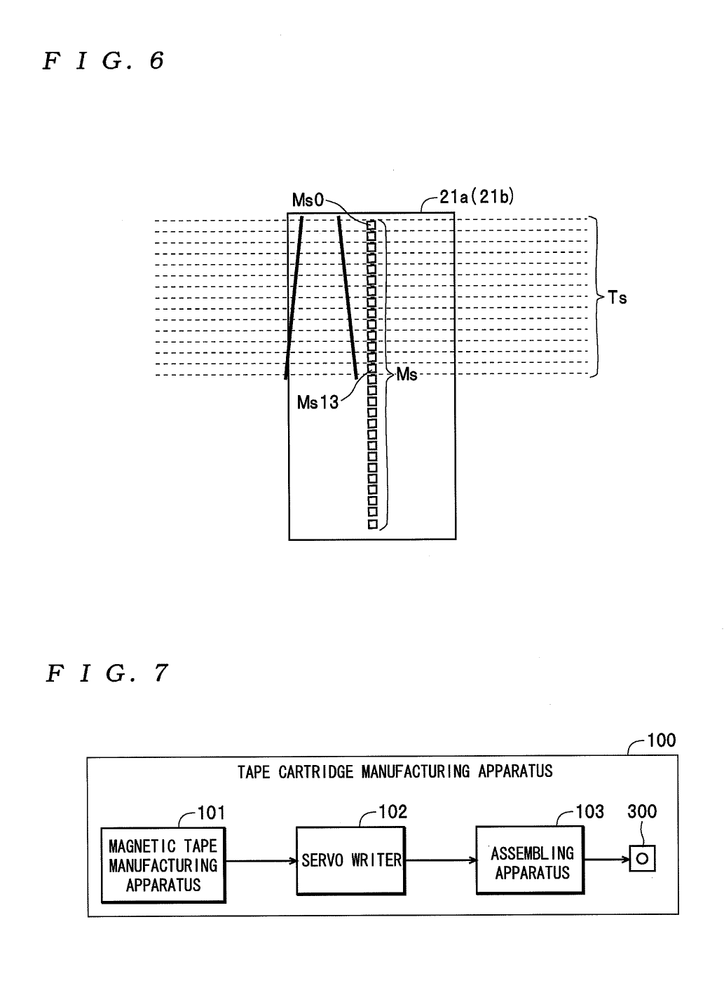

Here, in the drive apparatus 1, the number of detection elements Ms provided in the servo read heads 21 is set at twice the number of servo tracks Ts and the detection elements Ms are disposed at equal intervals with the same pitch as the pitch of the servo tracks Ts within a range that is around twice the length in the up-down direction (i.e., the width direction of the magnetic tape 301) of the servo patterns Ps. This means that in the drive apparatus 1, as shown in FIG. 3, in the initial state, the detection elements Ms14 to Ms27 out of the detection elements Ms are positioned on a servo track Ts, and as shown in FIG. 6, in a state where the head unit 14 has been moved downward in FIG. 3 by the maximum amount in the width direction of the magnetic tape 301, the detection elements Ms0 to Ms13 out of the detection elements Ms become positioned on the servo track Ts. That is, in the drive apparatus 1, two detection elements Ms out of the detection elements Ms will always become positioned at both ends in the up-down direction (i.e., the width direction of the magnetic tape 301) of the servo pattern Ps. Since the difference between the two measurement values Pm measured based on the detection signals Sd outputted from the two detection elements Ms positioned at both ends will be large, when the velocity fluctuation rate F is calculated using such difference, the measurement error in the measurement values Pm can be suppressed. As a result, it is possible to specify the velocity fluctuation rate F with a corresponding improvement in accuracy.

On the other hand, when data is recorded on the tape cartridge 300 using the drive apparatus 1, after the tape cartridge 300 has been set in the drive apparatus 1, the computer is operated to indicate the recording of data. When doing so, the controller 17 carries out tracking by carrying out various processes and control in the same way as the various processes and control in the reproducing process described above and causes the data read/write head 22 to record data. In this case also, accurate tracking can be carried out in the same way as in the reproducing process described above.

In this way, in the drive apparatus 1, each servo read head 21 is constructed so as to be capable of outputting the detection signals Sd for a plurality of positions that are separated in the width direction of the magnetic tape 301 inside one servo pattern Ps. This means that the controller 17 can specify the velocity fluctuation rate F of the movement velocity V of the magnetic tape 301 using measurement values Pm for the burst interval measured based on the detection signals Sd for at least two positions out of such separate positions. Therefore, according to the drive apparatus 1, since it is possible to correct the measurement values Pm based on the specified velocity fluctuation rate F so as to become the same value as the burst interval Pr, it will be possible to accurately measure the burst interval even when the movement velocity V is fluctuating. As a result, even if the movement velocity V is fluctuating, it will still be possible to accurately specify the tracking amount Tr, which means it will be possible to carry out accurate tracking.

In the drive apparatus 1, each servo read head 21 is constructed with a number of detection elements Ms that is twice the number of servo tracks Ts. This means that by disposing the detection elements Ms at equal intervals in a length that is around twice the length of a servo pattern Ps along the width direction of the magnetic tape 301, it will always be possible to position two out of the detection elements Ms at both ends in the height direction of a servo pattern Ps where the difference in the burst interval Pr is large. Accordingly, since the difference between the two measurement values Pm measured based on the detection signals Sd outputted from the two detection elements Ms is large, by calculating the velocity fluctuation rate F using such difference, the measurement error of the measurement values Pm can be suppressed. As a result, the velocity fluctuation rate F can be specified with a corresponding improvement in accuracy.

Next, the construction of the tape cartridge manufacturing apparatus 100 will be described. As shown in FIG. 7, the tape cartridge manufacturing apparatus 100 includes a magnetic tape manufacturing apparatus 101, the servo writer 102 and an assembling apparatus 103, and is constructed so as to be capable of manufacturing the tape cartridge 300.

After the magnetic tape manufacturing apparatus 101 has fabricated a web where a magnetic layer is formed on the surface of a long belt-shaped base film made of resin, the web is cut into predetermined widths to manufacture the magnetic tape 301.

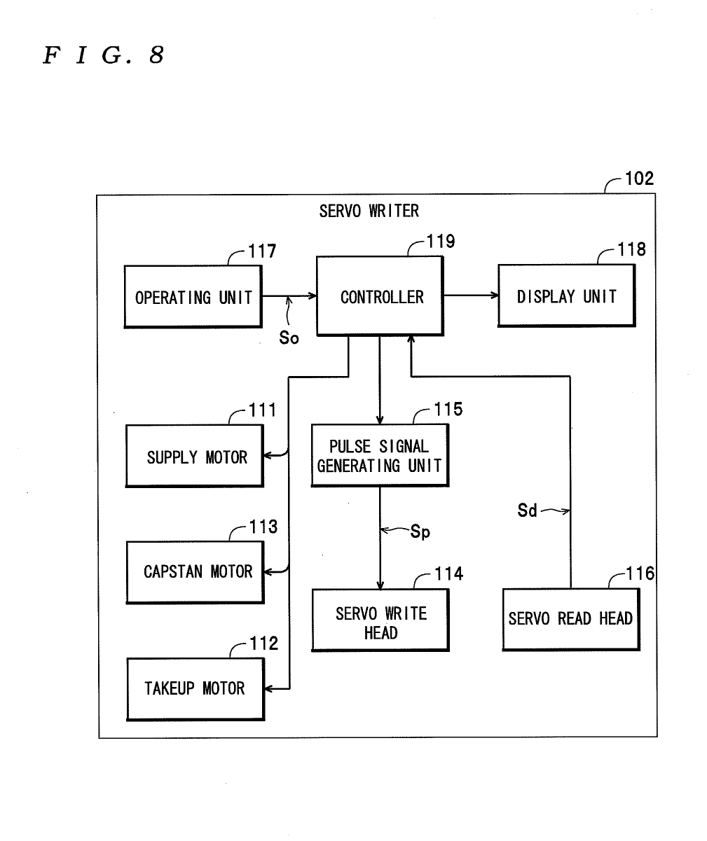

The servo writer 102 is one example of a “servo pattern writing apparatus” and a “magnetic tape testing apparatus” according to the present invention and as shown in FIG. 8 includes a supply motor 111, a takeup motor 112, a capstan motor 113, a servo write head 114 (a “write head” for the present invention), a pulse signal generating unit 115, the servo read head 116 (a “detector” for the present invention), an operating unit 117, a display unit 118, and a controller 119. The servo writer 102 is constructed so as to be capable of writing (recording) the servo patterns Ps on the magnetic tape 301 and of testing whether the magnetic tape 301 on which the servo patterns Ps have been written is defective or non-defective.

The supply motor 111 feeds out the magnetic tape 301 wound around a supply reel, not shown, by rotating a supply reel and the takeup motor 112 winds on the magnetic tape 301 by rotating a takeup reel, also not shown. The capstan motor 113 rotates a capstan, not shown at a predetermined rotational velocity in accordance with control by the controller 119 to move the magnetic tape 301 at a predetermined velocity. Note that the motors 111, 112, 113, the capstan, and the like construct a “moving mechanism” for the present invention.

The servo write head 114 records (writes) the servo patterns onto the (moving) magnetic tape 301 in accordance with a pulse signal Sp outputted from the pulse signal generating unit 115. The pulse signal generating unit 115 outputs the pulse signal Sp to the servo write head 114 in accordance with control by the controller 119.

The servo read head 116 is constructed of a plurality (for example, two) of detection elements Ms that are the same as the detection elements Ms of the head unit 14 in the drive apparatus 1 described above, and in the same way as the head unit 14, the servo read head 116 outputs detection signals Sd for a plurality of positions that are separated in the width direction of the magnetic tape 301 inside one servo pattern Ps. The operating unit 117 is constructed of a variety of switches and keys and outputs an operation signal So in accordance with an operation of such switches and keys. The display unit 118 displays various values such as the measurement values Pm, the result of the judgment of defective or non-defective for the magnetic tape 301 made by the controller 119, and the like in accordance with control by the controller 119.

The controller 119 corresponds to a “controller” and a “determining unit” for the present invention and controls the various component elements of the servo writer 102 in accordance with the operation signals So outputted from the operating unit 117. The controller 119 also measures the respective burst intervals at two positions in a servo pattern Ps (one example of “at least two positions” for the present invention) based on the detection signals Sd outputted from the servo read head 116. In the same way as the controller 17 of the drive apparatus 1, the controller 119 specifies (calculates) the velocity fluctuation rate F of the movement velocity V of the magnetic tape 301 based on the measurement values Pm of the burst intervals using the calculation method described above and controls the movement velocity V of the magnetic tape 301 using the motors 111, 112, 113 so that the velocity fluctuation rate F approaches 1.0 (or in other words, so that the velocity fluctuations are reduced). In addition, the controller 119 carries out a determination process that determines whether the magnetic tape 301 on which the servo patterns Ps have been written by the servo writer 102 is defective or non-defective.

Next, the operation of the magnetic tape manufacturing apparatus 101, the servo writer 102, and the assembling apparatus 103 (which construct the tape cartridge manufacturing apparatus 100) during the manufacturing of the tape cartridge 300 by the tape cartridge manufacturing apparatus 100 will be described.

First, after the magnetic tape manufacturing apparatus 101 has fabricated a web by forming a magnetic layer on the surface of a base film, the web is cut into predetermined widths to manufacture the magnetic tape 301.

Next, using the servo writer 102, the servo patterns Ps are written onto the magnetic tape 301 manufactured by the magnetic tape manufacturing apparatus 101. More specifically, by operating the operating unit 117, a start of recording is indicated after inputting various conditions such as the movement velocity V of the magnetic tape 301 and the pitch of the servo patterns Ps and a variety of values such as the upper and lower values that set the tolerated range for the velocity fluctuation rate F (a “predetermined range” for the present invention). Next, in accordance with the operation signal So outputted from the operating unit 117, the controller 119 controls the capstan motor 113 to move the magnetic tape 301 at the set movement velocity V and controls the supply motor 111 and the takeup motor 112 to feed out and wind on the magnetic tape 301. After this, the controller 119 controls the pulse signal generating unit 115 to start outputting the pulse signal Sp. Next, the servo write head 114 starts recording (writing) the servo patterns Ps on the servo bands 312 of the magnetic tape 301 in accordance with the pulse signal Sp.

The detection elements Ms of the servo read head 116 detect the segments Se of a recorded servo pattern Ps and output the detection signals Sd. The controller 119 specifies the velocity fluctuation rate F based on such detection signals Sd in a burst interval measuring process executed by the controller 17 of the drive apparatus 1 described above (more specifically, the velocity fluctuation rate F is calculated according to Equation (12) given above). In this case, as described above, the value of the denominator on the right side of Equation (12) is constant regardless of the position of the detection elements Ms (i.e., the value of the denominator is universally determined by the distance Td between the detection elements Ms along the width direction of the magnetic tape 301). Accordingly, even if the magnetic tape 301 has moved along the width direction thereof or the servo read head 116 has moved along the width direction of the magnetic tape 301, it will still be possible to accurately specify the velocity fluctuation rate F without being affected by such movement.

After this, the controller 119 controls the movement velocity V of the magnetic tape 301 using the capstan motor 113 so that the specified velocity fluctuation rate F approaches 1.0 (i.e., so that the velocity fluctuations are reduced). More specifically, the controller 119 increases the velocity when the velocity fluctuation rate F is above 1 (i.e., when the movement velocity V is slower than the set velocity) and decreases the velocity when the velocity fluctuation rate F is below 1 (i.e., when the movement velocity V is faster than the set velocity). Here, by carrying out such control, the controller 119 can keep the movement velocity V of the magnetic tape 301 constant, and as a result, the servo patterns Ps are recorded at equal intervals.

The controller 119 carries out a determination process that compares the specified velocity fluctuation rate F and the upper and lower limit values of the velocity fluctuation rate F that have been inputted and determines whether the magnetic tape 301 is defective or non-defective. In this determination process, when the velocity fluctuation rate F is outside the range of the upper and lower limits, the controller 119 determines that the magnetic tape 301 is defective and has an indication of this displayed on the display unit 118. By having the controller 119 carry out this determination process, as one example, even if the servo patterns Ps were recorded on the magnetic tape 301 in a state where the movement velocity V of the magnetic tape 301 was fluctuating more than the predetermined velocity fluctuation rate F before control of the movement velocity V of the magnetic tape 301 via the capstan motor 113 described above could be started, it will still be possible to exclude such magnetic tape 301 (i.e., a magnetic tape 301 where the recorded state of the servo patterns Ps is not favorable) from the products.

Next, at a point when the magnetic tape 301 has moved by a predetermined distance (i.e., when a predetermined period has elapsed from the start of writing the servo patterns Ps), the controller 119 controls the pulse signal generating unit 115 to stop outputting the pulse signal Sp. The controller 119 controls (i.e., stops) the operation of the supply motor 111, the takeup motor 112, and the capstan motor 113 to stop the movement, feeding out, and winding on of the magnetic tape 301. By doing so, the writing of the servo patterns Ps onto the magnetic tape 301 and the testing of the magnetic tape 301 on which the servo patterns Ps have been written is completed.

In this way, in the servo writer 102, the servo read head 116 is constructed so as to be capable of outputting the detection signal Sd at a plurality of positions that are separated in the width direction of the magnetic tape 301 inside one servo pattern Ps. This means that the controller 119 can use the measurement values Pm for the burst intervals measured based on the detection signals Sd for at least two positions out of the plurality of positions to specify the velocity fluctuation rate F of the movement velocity V of the magnetic tape 301. Therefore, according to the servo writer 102, by controlling the motors 111, 112, 113 based on the specified velocity fluctuation rate F so that the velocity fluctuation rate F approaches 1.0 (i.e., so that the velocity fluctuations are reduced), it is possible to suppress fluctuations in the movement velocity V of the magnetic tape 301. As a result, it is possible to record the servo patterns Ps at equal intervals.

According to the servo writer 102, the controller 119 determines that the magnetic tape 301 is defective when the specified velocity fluctuation rate F is outside the upper and lower limits (i.e., a predetermined range). By doing so, if the servo patterns Ps were recorded on the magnetic tape 301 in a state where the movement velocity V of the magnetic tape 301 was fluctuating with a velocity fluctuation rate F that is outside the predetermined range, it will be possible to exclude such magnetic tape 301 (i.e., a magnetic tape 301 where the recorded state of the servo patterns Ps is not favorable) from the products.

Note that the present invention is not limited to the construction described above. For example, although an example where the present invention has been applied to the drive apparatus 1 has been described, it is also possible to apply the present invention to an apparatus that is dedicated to measuring the burst interval (i.e., a “burst interval measuring apparatus” according to the present invention). Such burst interval measuring apparatus includes servo read heads (a “detector” for the present invention) with the same functions as the servo read heads 21a, 21b of the head unit 14 in the drive apparatus 1 and a measuring unit with the same functions as the controller 17 of the drive apparatus 1 and measures the burst interval by carrying out the burst interval measuring process described above (i.e., a “burst interval measuring method” according to the present invention).

Also, although an example where the head unit 14 includes a number (in the example described above, twenty-eight) of the detection elements Ms that is twice the number (in the example described above, fourteen) of the servo tracks Ts has been described, the number of detection elements Ms is not limited to this and can be set at an arbitrary number that is at least twice the number of the servo tracks. Also, although an example where the velocity fluctuation rate F is specified using the measurement value Pm of the burst intervals measured based on the detection signal Sd outputted from two detection elements Ms out of the detection elements Ms has been described, it is also possible to use a construction that specifies the velocity fluctuation rate F using measurement values Pm measured based on the detection signals Sd outputted from an arbitrary number of detection elements Ms that is three or higher.

In addition, although the servo writer 102 that functions both as a “servo pattern writing apparatus” and a “magnetic tape testing apparatus” according to the present invention has been described as an example, it should be obvious that the present invention can be applied to an apparatus that functions as one of a servo pattern writing apparatus and a magnetic tape testing apparatus.

What is claimed is:

1. A burst interval measuring apparatus comprising:
a detector that outputs detection signals that can measure a burst interval of servo patterns for a tracking servo that have been written on a magnetic tape in a length direction of the magnetic tape; and
a measuring unit that measures the burst interval based on the detection signals,
wherein the detector is constructed so as to be capable of outputting the detection signals that can measure the burst interval at a plurality of positions that are separated in a width direction of the magnetic tape inside one of the servo patterns, and
the measuring unit uses measurement values for the burst interval at at least two positions out of the plurality of positions that have been measured based on the detection signals to specify velocity fluctuations in a movement velocity of the magnetic tape in the length direction thereof and corrects the measurement values based on the velocity fluctuations.

2. A burst interval measuring method that measures, based on detection signals outputted from a detector, a burst interval of servo patterns for a tracking servo that have been written on a magnetic tape in a length direction of the magnetic tape, the burst interval measuring method comprising:
measuring the burst interval based on the detection signals at at least two positions that are separated in a width direction of the magnetic tape inside one of the servo patterns;
specifying velocity fluctuations in a movement velocity of the magnetic tape along the length direction thereof using measurement values for the burst interval; and
correcting the measurement values based on the velocity fluctuations.

3. A drive apparatus comprising:
a magnetic head that carries out at least one of reproducing of data recorded on a magnetic tape and recording of data on the magnetic tape;
a detector that outputs detection signals that can measure a burst interval of servo patterns for a tracking servo that have been written on the magnetic tape in a length direction of the magnetic tape; and
a controller that measures the burst interval based on the detection signals and carries out tracking control of the magnetic head using measurement values for the burst interval,
wherein the detector is constructed so as to be capable of outputting the detection signals that can measure the burst interval at a plurality of positions that are separated in a width direction of the magnetic tape inside one of the servo patterns, and
the measuring unit uses measurement values for the burst interval at at least two positions out of the plurality of positions that have been measured based on the detection signals to specify velocity fluctuations in a movement velocity of the magnetic tape in the length direction thereof, corrects the measurement values based on the velocity fluctuations, and carries out the tracking control using the corrected measurement values.

4. A drive apparatus according to claim 3,
wherein the detector includes a number of detection elements that output the detection signals that is equal to at least (twice the number of servo tracks in a servo band in which the servo pattern has been written minus one), and
the measuring unit specifies the velocity fluctuations using the measurement values for two positions out of the plurality of positions that have been measured based on the detection signals outputted from two detection elements out of the detection elements.

5. A servo pattern writing apparatus comprising:
a moving mechanism that moves a magnetic tape along a length direction thereof;
a write head that writes servo patterns for a tracking servo along the length direction of the magnetic tape while the magnetic tape is moving;
a controller that controls the moving mechanism; and
a detector that outputs detection signals that can measure a burst interval at a plurality of positions that are separated in a width direction of the magnetic tape inside one of the servo patterns,
wherein the controller specifies velocity fluctuations in a movement velocity of the magnetic tape along the length direction thereof using measurement values for the burst interval at at least two positions out of the plurality of positions that have been measured based on the detection signals and controls the moving mechanism so as to reduce the velocity fluctuations.

6. A magnetic tape testing apparatus that tests a magnetic tape on which servo patterns for a tracking servo have been written by a servo pattern writing apparatus that writes the servo patterns along a length direction of the magnetic tape while moving the magnetic tape in the length direction,
the magnetic tape testing apparatus comprising:
a detector that outputs detection signals that can measure a burst interval at a plurality of positions that are separated in a width direction of the magnetic tape inside one of the servo patterns; and
a determining unit that specifies velocity fluctuations in a movement velocity of the magnetic tape in the length direction using measurement values of the burst interval for at least two positions out of the plurality of positions that have been measured based on the detection signals, and determines that the magnetic tape is defective when the velocity fluctuations are outside a predetermined range.
